(19) United States
(12) Patent Application Publication
(10) Pub. No.: US 2006/0212433 A1
(43) Pub. Date: Sep. 21, 2006

(54) Prioritization of search responses system and method

(76) Inventors: Michael S. Stachowiak, San Francisco, CA (US); Zaw Thet, San Francisco, CA (US); Markus Nordvik, San Francisco, CA (US)

Correspondence Address: PILLSBURY WINTHROP SHAW PITTMAN LLP, P.O. BOX 10500, MCLEAN, VA, 22102, US

(21) Appl. No.: 11/345,628

(22) Filed: Jan. 31, 2006

Related U.S. Application Data
(60) Provisional application No. 60/648,959, filed on Jan. 31, 2005.
(60) Provisional application No. 60/648,731, filed on Jan. 31, 2005.
(60) Provisional application No. 60/648,733, filed on Jan. 31, 2005.

(51) Int. Cl. G06F 17/30

(52) U.S. Cl. 707/3

(57) ABSTRACT

The present invention provides systems and methods for accurately parsing an information retrieval query and for generating accurate results based on the query. Queries are processed as a collection of atomic terminals of one or more search domains. The systems and methods typically implement a lexicon comprising a set of associations between known terminals and the phrase types to which they belong and a grammar comprising a set of deterministic syntax rules for translating a single phrase type of the domain into an ordered set of phrase types of similar expressiveness. Parsing includes separating a query into identifiable terminals of the domain language and comparing a collection of phrase types against the grammar to see if any subset of phrases types can be grouped together and translated into a higher level phrase type. The invention enables generation of a collection of potentially ambiguous semantic phrase types capable of assigning meaning to the uncovered syntactical structure of the query terminals.

### RELATED APPLICATIONS

The present application claims priority from provisional patent application No. 60/648,959 entitled “Short Query-based System and Method for Content Searching,” filed Jan. 31, 2005, and from provisional patent application No. 60/648,731 entitled “Prioritization of Search Responses System and Method,” filed Jan. 31, 2005, and from provisional patent application No. 60/648,733 entitled “Automated Transfer of Data from PC Clients,” filed Jan. 31, 2005, which provisional applications are incorporated herein by reference and for all purposes.

### BACKGROUND OF THE INVENTION

1. Field of the Invention

The present invention generally relates to information searching techniques. More particularly, the present invention relates to the provision of access to information using communications devices with limited capabilities.

2. Description of Related Art

Current information searching methods operate by parsing alphanumeric data to retrieve phrases, terms and words for searching. Often, a single alphanumeric string returns results that include large numbers of potential matches. In practice, many—often a majority—of the results are irrelevant, duplicative or otherwise invalid. The quality of results often depends on the search string provided and usually requires detailed and focused terms.

Most search engines use a parser to extract search terms and generate a result. Simply put, the purpose of parsing a string is to extract a meaning from the string. While relatively easy for a human to understand, a computer does not have the same vocabulary or ability to fit the meanings of words together. Many search engines today have not been required to perform complex parsing because users are forced to enter specific types of queries in separate boxes. For example, in locating a retail store, a search engine usually provides an input box for a home address separate from an input box for a type of retail store sought. With the advent of widespread mobile communications, limited input is available and, in many current systems, such as a text messaging medium, only one input box may be available and only limited interaction is possible. Thus the degree of difficulty of creating a useful search string increases exponentially, resulting in low quality results for mobile devices with limited input capability.

### SUMMARY OF THE INVENTION

Embodiments of the present invention provide systems and methods for accurately parsing an information retrieval query in order to provide an accurate set of results for that query. In the context of the current invention, parsing can be thought of as the analysis of the components of a query and how they interact together to form a collective interpretation. According to aspects of the present invention, queries may be treated as being comprised of a collection of atomic terminals of the search domain. When implementing an information retrieval system in the domain of natural languages, such atomic terminals consist of individual words of the language. Terminals of the search domain can be categorized together as representations of a particular type, herein referred to as phrase types. To parse the intended semantic meaning from a query, the invention relies on two knowledge bases for analysis: a lexicon and a grammar. A lexicon of the search domain comprises a set of associations between known terminals and the phrase types to which they belong. A grammar of the search domain comprises a set of deterministic syntax rules for translating a single phrase type of the domain into an ordered set of phrase types of similar expressiveness, and vice versa. Within a grammar of a search domain, certain phrase types also have a known semantic interpretation—an association of meaning between the corresponding syntactical parts that comprise the phrase type. This subset of phrase types will be referred to as semantic phrase types.

In certain embodiments of the invention, parsing begins by separating a query into identifiable terminals of the domain language. The lexicon is leveraged to identifying the phrase types to which the terminals of the query belong. With known terminals of the query identified to be of a particular phrase type (some terminal symbols may be unidentifiable), the collection of phrase types is compared against the grammar to see if any subset of phrases types can be grouped together and translated into a higher level phrase type. This process is repeated until the phrase types can be grouped no further according to the grammar rules and all semantic phrase type representations of the query have been uncovered. The end result is a collection of potentially ambiguous semantic phrase types capable of assigning meaning to the uncovered syntactical structure of the query terminals.

According to aspects of the present invention, the order in which the parsing is performed is inconsequential to the end result. The process can begin with translation of the query terminals into phrase types using the lexicon and working up to semantic phrase types. The process can also begin with the full collection semantic phrase types and work down to the terminals in the query. In certain embodiments, a combination of both of these processes can be simultaneously performed.

Additionally, in line with this invention, queries and the corresponding terminals which they comprise can be represented as strings of a natural language and can also comprise audio sound bites, visual cues, or any other form of atomic subcomponent of the search domain.

Embodiments of the present invention may be configured for use in all types of information retrieval systems, accessible from wireless communication systems, Internet and other suitable communications media.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a drawing showing the primary components of the present invention;

FIG. 2 is an illustration outlining the components of a parser

FIG. 3 is a flowchart describing one possible implementation of a parser as it takes an incoming query and generates a collection of ambiguous query interpretations;

FIG. 4 is an drawing of a system used to disambiguate a collection of semantic phrase types represented by a query string;

FIG. 5 is a diagram of a text-based lexicon;

FIG. 6 is a diagram of a text-based syntactical grammar;

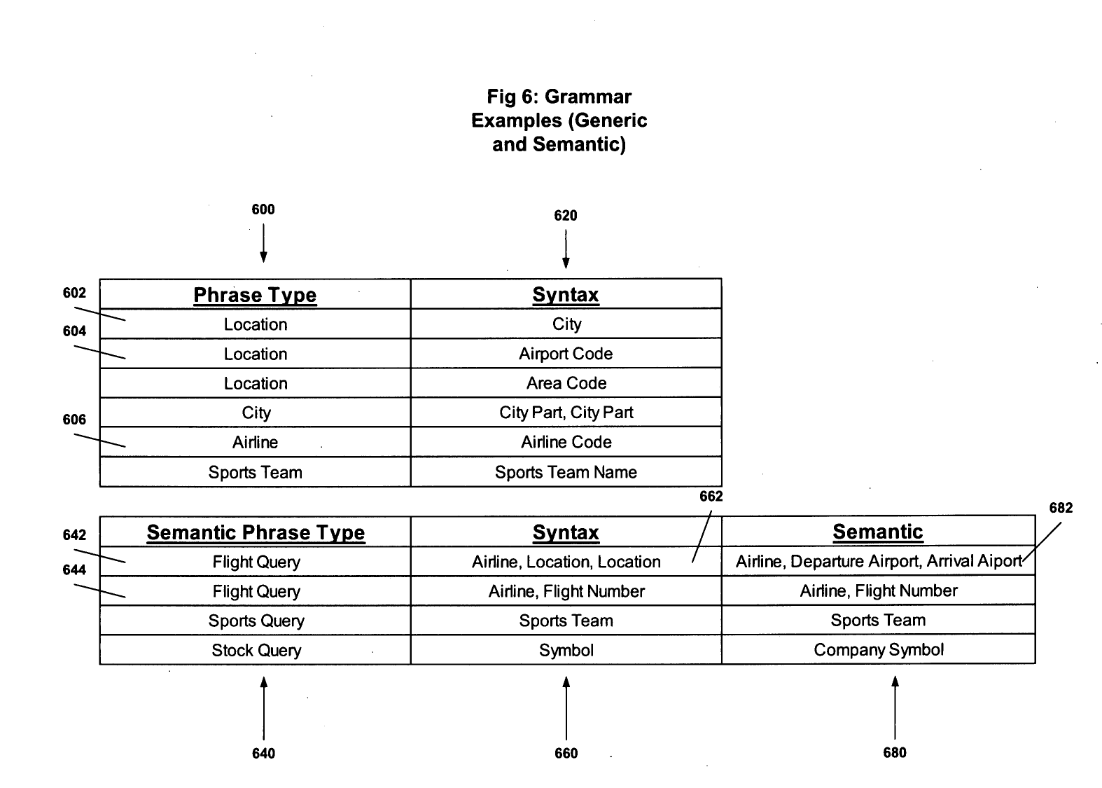

FIG. 7 is a drawing showing the syntactic interpretations the parser generates from an example query.

FIG. 8 is a drawing showing the syntactic interpretations the parser generates from another example query.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

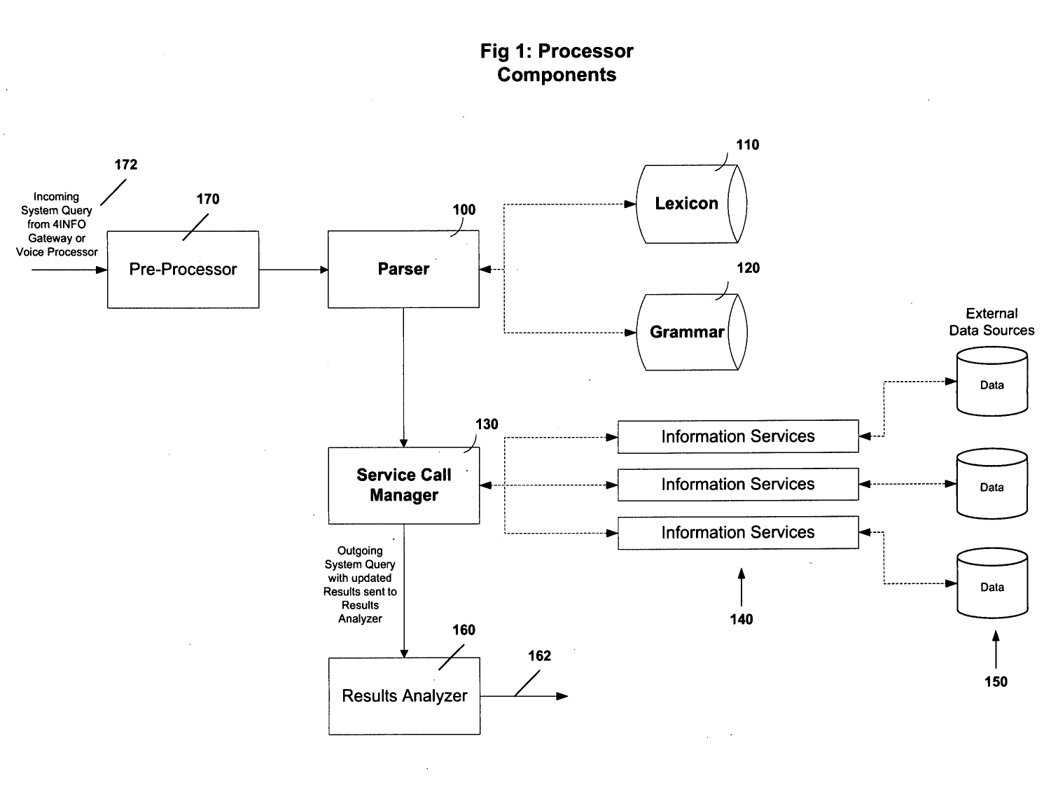

Referring to FIG. 1, embodiments of the invention provide a system for receiving ambiguous queries 172, parsing the query to obtain a collection of semantic interpretations, retrieving information based on the derived semantic interpretations, and subsequently disambiguating the semantic interpretations and their associated result sets in order to determine the optimal result set to return. The ambiguous queries 172 may be received from a plurality of input devices, including computers, SMS messaging-capable devices and voice response systems. In some embodiments, a preprocessor 170 prepares the ambiguous queries 172 for parsing. Preprocessing of a query may include any action deemed helpful to the act of parsing, including the translation of a query from a first domain to a second domain, where the second domain is better understood by a parser 100. A domain is a set or logical division of certain types of information that contain similarities. For example, translation between domains occurs where a query received as a digital audio file of spoken English is transposed into an alphanumeric string representing English language words of similar expressiveness. Preprocessing also includes operations performed to improve the efficiency of the parser 100. For example, many embodiments maintain a set of commonly entered search queries and a preprocessor 170 initially searches the set for similarities with a received ambiguous query 172. Such similarities may yield information that can be leveraged in parsing the query. In at least some embodiments, the preprocessor 170 can also add information on user location, history and profile.

In certain embodiments of the invention, the parser 100 analyzes the syntactical structure of an ambiguous query 172 in order to derive a collection of semantic interpretations. Analysis may be performed with the aid of a lexicon 110 and a grammar 120. A lexicon 110 is typically a predefined set of deterministic rules for mapping known terminals of a search domain to their respective phrase types. A grammar 120 is typically a predefined set of deterministic rules for mapping a first set of phrase types to a second set of phrase types.

In certain embodiments, parsed semantic interpretations of the ambiguous query can be sent to a plurality of information services 140 for result processing, where each of the plurality of information services 140 individually caters to one aspect of the search domain. In such an arrangement, each of the plurality of information retrieval services is configured to receive and respond to a semantic interpretation of a query and to retrieve results related to the semantic interpretation. In one embodiment of the invention, information services may include a sports service, a directory service (such as yellow pages) and a flight status service, along with other similar search services. In another embodiment, an information service can be implemented using a typical web/document search engine that searches for a collection of terms within a document. Each of these services are able to receive semantically interpreted queries such as “What is the score of the Lakers game”, “Where can I get coffee in San Francisco, Calif.”, and “Is United flight 650 on time?”, and return results relevant to those queries. A set of results returned for a semantic interpretation may then be analyzed by a results analyzer 160 to obtain an optimal subset of results 162. The process used to analyze a result set varies according to factors including type of query, type of result sought and prior usage. For example, results may be analyzed against prior system usage to determine the optimal set to be returned.

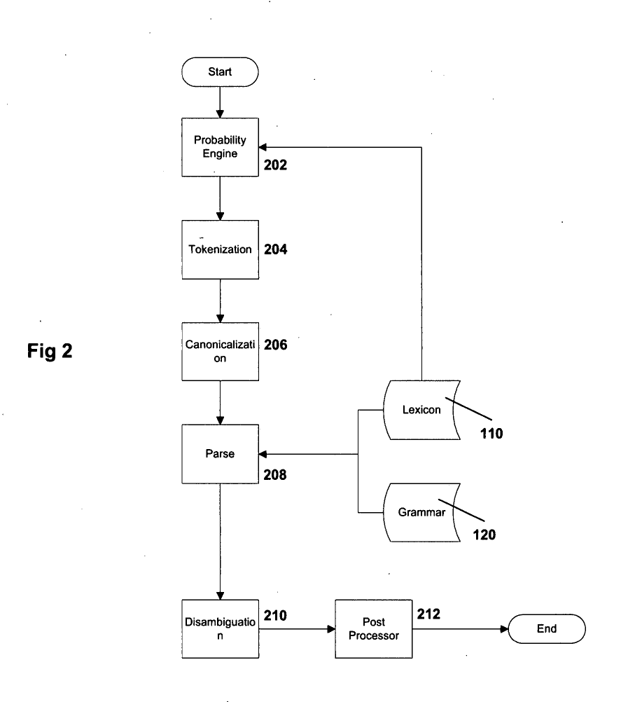

Referring now to FIG. 2 together with FIG. 1, the operation of the parser may be understood. Parsing is initiated at step 200 when an ambiguous query 172 is received from an outside system. The ambiguous query 172 may optionally be preprocessed by a preprocessor 170 to extract information helpful to the process of parsing. The ambiguous query and any extracted information typically include one or more terminals associated with a search domain. For the purpose of this discussion, terminals may be considered to be atomic components of a query that may be associated in meaning with low-level building blocks of the search domain. For example, in the English Language domain, terminals are the known words of the language. In the domain of audio clips, terminals are short sound bites containing a meaningful collection of noise.

At step 202, the ambiguous query, together with any extracted information is analyzed by a probability engine. The probability engine attempts to determine the nature of an ambiguous query by examining terminals present in the ambiguous query. For example, the presence of one or more airline scheduling terminals would cause the probability engine to assign a high probability that the ambiguous query is a travel-related query.

At step 204, a tokenized query is generated by separating one or more terminals present in the ambiguous query 172. In the example of the English Language domain, queries are received as words separated by spaces and punctuation and tokenizing involves separating the query into an ordered collection of individual words. In certain embodiments, a morphological analysis is performed at step 206 on the one or more terminals to translate them into a more recognizable canonical form. This form of analysis may be referred to as “stemming.” For example, in the domain of English language queries, stemming entails stripping prefixes and suffixes, plural designations, and other non-essential components to determine the root form of the terminal. In another example, tokenization in the domain of audio clips reduces background noise.

The parsing process continues at step 208 by analyzing the syntactical structure of the ordered set of terminals found in the tokenized query to extract semantic meaning. This latter analysis may include the use of one or more grammar 120 and one or more lexicon 110 associated with the domain. The parser 100 typically parses in multiple simultaneous “directions” such that, parsing operates from the direction of the terminals up to phrase types while parsing downward from root phrase types of the grammar to the terminals. This approach may be analogized as simultaneously working up from a problem (query) to a solution (interpretation) while working down from a solution to the problem. This approach may provide efficiencies derived from a reduction in the number of possibilities that must be examined during the analysis. Specifically, the approach allows the parser 100 to avoid consideration of a considerable number of grammar rules and phrase types incapable of providing a complete parse.

It will be appreciated that, for each derived interpretation the parser 100 may send a request to an information service appropriate for the phrase type detected in the tokenized query. For example, where a semantic interpretation indicates a flight query phrase type, the interpretation is sent as a request for information to a Flight Service for processing. Each interpretation may be passed to an information service in this fashion and a set of results pertaining to the interpretation is typically returned. It will be appreciated that, in some cases, multiple results may be derived.

Having obtained a set of results for one or more derived interpretations, the set of results is disambiguated at step 210 to determine an optimal result.

Many embodiments include a post-processing stage at step 212 after the interpretations and their corresponding results have been disambiguated and an optimal result has been determined. Post-processing typically involves analysis of the ambiguous query, the tokenized query, semantic interpretation of the tokenized query and the set of results in view of information data derived from previous queries. The post-processing analysis provides information that may be used to improve future search results and, in at least some embodiments, to improve the search process. For example, the post-processing analysis may uncover one or more new terminals that may be used for processing future similar queries. In this latter example, the one or more new terminals may include misspelled versions of terminals previously known in the system. In another example, the post-processing analysis may reveal information that could be used to adjust prioritization of certain semantic phrase types within the probability engine or discover new grammar rules and so on.

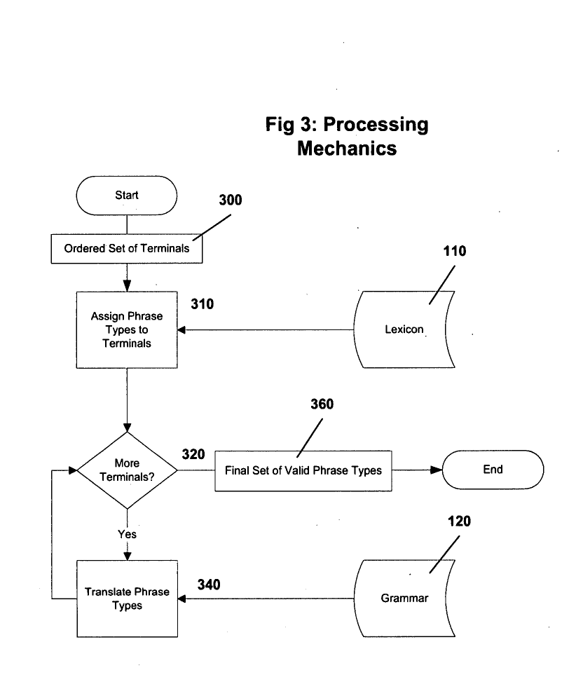

The flowchart of FIG. 3, viewed in conjunction with FIG. 1, provides an outline of a simplified example of parsing according to aspects of the present invention. At step 300, an ordered set of terminals of a search domain are received by the parser 100. The set of terminals is obtained by tokenization and optional morphological analysis of an ambiguous query. In this example, each terminal of the set of terminals is mapped at step 310 to an associated set of phrase types using a lexicon. As an illustrative example, a terminal such as “United” may be mapped to the collection of phrase types that include “Airline” and “Sports Team”. The mapping process continues until every terminal in the set of terminals has been mapped to its full collection of phrase types. Next, at steps 320 and 340, analysis continues in an iterative process of phrase type translations using a grammar 120 to control translation. This control is implemented by inspecting the associated set of phrase types to determine if translations are possible using known rules of the grammar 120. If translations are possible, the phrase types are translated into a new set of similar phrase types using the known rules of the grammar 120. The new set of phrase types is then inspected to determine if further translations are possible. Thus the iterative process continues until no further translations can be made with the set of known rules of the grammar 120. At step 360, a set of all valid phrase type representations of the query is produced. Some of the valid phrase types will be semantic phrase types, from which a semantic interpretation of the query terminals can be assigned from a syntactical structure.

It will be appreciated that other embodiments of the invention may implement a different parsing process. For example, in at least some embodiments, parsing is implemented in reverse order, commencing with a set of semantic phrase types that is used to obtain terminals of the query string through grammar-based translation. Likewise, the process of parsing could be performed simultaneously in both directions: working up from the terminals while simultaneously working down from the collection of semantic phrase types.

Upon determining a set of possible semantic phrase type interpretations for a given query, a process of disambiguation begins. Disambiguation entails determining the most likely interpretation from the set of possible interpretations. Given the ability of prior art systems to display large amounts of data to a user, disambiguation is not considered important in conventional systems. However, in embodiments of the present invention, disambiguation can play an important role. For example, users who receive results via a text message on cell phones may be generally limited by a 160 character per message restriction and disambiguation is therefore, crucially important. While the objectives of most query-generating users may not be ambiguous, the representation of those objectives in query form is often ambiguous. The art of disambiguation entails looking at each ambiguous interpretation and determining a most likely intended objective. Considering an example of an objective of locating the status of an American Airlines flight having a flight number 650, a user may represent the objective as the query “American 650.” While this may be interpreted through the act of parsing by an information retrieval system as a request for the status of American flight 650, it may also be interpreted as a request for American food in area code 650. As far as the act of parsing is concerned, both interpretations are valid semantic representations of the query.

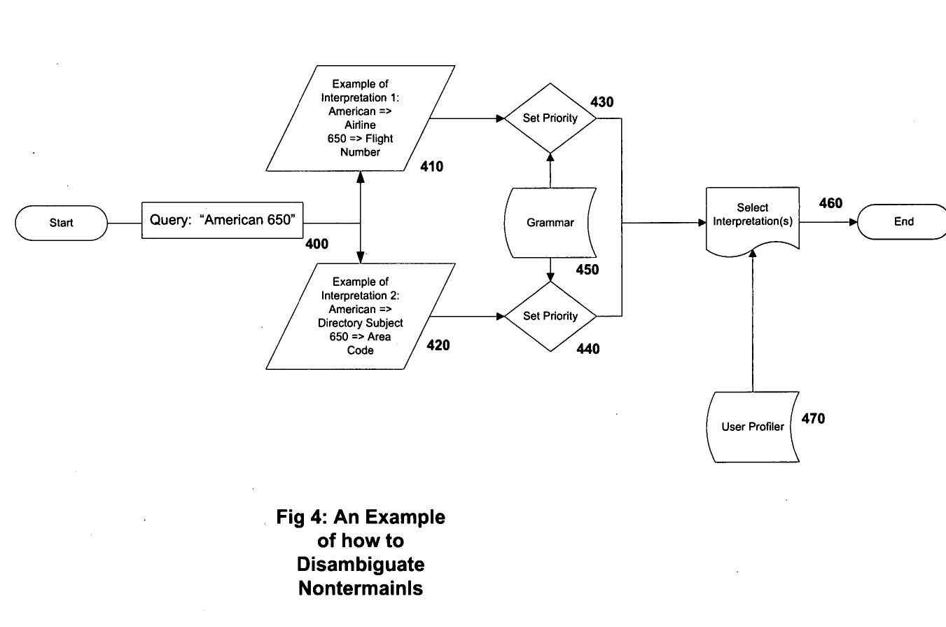

FIG. 4 provides a flow diagram that illustrates an example of disambiguation associated with the example depicted in FIG. 1. In this embodiment, disambiguation is performed by assigning priorities to semantic phrase types. The parser can then disambiguate a collection of ambiguous semantic phrase type interpretations for a query by comparing priorities of each phrase type interpretation and selecting the interpretation with the highest priority. As an illustrative example, consider the processing of the aforementioned query “American 650” shown at step 400. In the example, the parser 100 determines that two possible semantic phrase type interpretations exist for this query: a request for the status of American flight 650 as shown at step 410 and, at step 420, a request for American food in or around area code 650. A unique priority may be set at steps 430 and 440 for each of these phrase type interpretations where the phrase type interpretation is listed with an associated priority in a grammar 450. Next, at step 460, the parser compares the set priorities and selects the interpretation with higher priority.

In many embodiments, the selection of an interpretation may be made based on factors that include past system usage and user profile information 470. For example, in the “American 650” example, the airline interpretation may have a higher priority based on prior queries entered by the querying user, coincidence of origin or destination of the flight and a residence associated with the querying user and statistical analysis of similar queries entered by all system users or a group of users that may be associated with the querying user.

It will be appreciated that priority may be adjusted if partial phrase type matches are available because of incomplete query or misspelled queries. Thus, the priority mechanism may also be used to assign priorities to valid grammar rules where the received query does not use all terminal symbols present in the received query. For example, consider a query including the words “lakers score halftime,” where the word “lakers” is included in the lexicon as a sports team and the word “score” is included in the lexicon as a sports indicator but the word “halftime” does not appear in the Lexicon. A priority ranking component of the parser accordingly decreases the priority of the received query from the priority of “lakers score” recognizing that although the received query matches a valid semantic phrase type in the grammar, it does not utilize all terminals in the query.

In many embodiments of the invention, priority for a given phrase type is developed heuristically through system usage. In these embodiments, a typical priority is created and derived from a plurality of sources including intuition (for example, as an initial criteria before a knowledge base is developed), knowledge of a search domain and combination with or split from an existing usage database. Over time, systems can adapt priority for the phrase type based on information including received queries and associated responses and follow-up queries. This information is typically learned from usage and post processing queries and the information improves overall system accuracy.

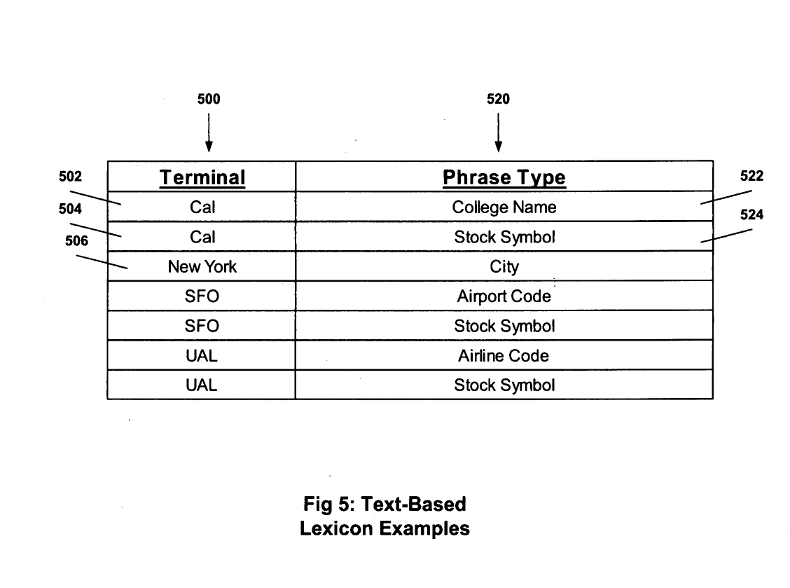

FIG. 5 provides a table illustrating the use of a text based lexicon capable of translating terminals of a query domain into phrase types of that domain, and vice versa. For the purpose of illustration, the figure depicts, generally at 500, a plurality of terminals of the English language, such as “Cal” 502, 504 and “New York” 506. It will be appreciated that some terminals may be ambiguous since they can be associated with multiple phrase types. An example of an ambiguous terminal symbol is the term “Cal” 502 and 504, which is ambiguously associated with the phrase types “college name” 522 and “stock symbol” 524.

In many embodiments of the invention, lexicons are built through system usage. In these embodiments, a typical lexicon is created with seed terms derived from a plurality of sources including intuition, knowledge of a search domain and combination with or split from an existing lexicon. Over time, systems adapt lexicons based on information including received queries and associated responses and follow-up queries. This information is typically learned from usage and post processing queries and the information enables the creation of new terminals and corresponding phrase types.

FIG. 5 illustrates an example of a grammar that comprises a set of deterministic syntactical rules for translating a single phrase type of the domain into an ordered set of phrase types of similar expressiveness, and vice versa. For the purpose of illustration, the figure depicts phrase types 600 of the English language, such as “location” 602 and 604 and “airline” 606. Also depicted is a plurality of semantic phrase types 640, in which syntax 660 associated with the semantic phrase type 640 can be translated into semantic interpretations 680. These include examples such as “flight query” 642 and 644 where the syntactical representation of the phrase type that is represented by the collection of phrase types “airline, location, location” 662 can be semantically interpreted to represent a flight query of “airline, departure location, arrival location” 682.

In many embodiments of the invention, grammars are built through system usage. In these embodiments, a typical grammar is created with seed terms derived from a plurality of sources including intuition, knowledge of a search domain and combination with or split from an existing grammar. Over time, systems can adapt grammars based on information including analysis of received queries and associated responses and follow-up queries. This information is typically learned from usage and post processing queries and the information enables the creation of new terminals and corresponding phrase types.

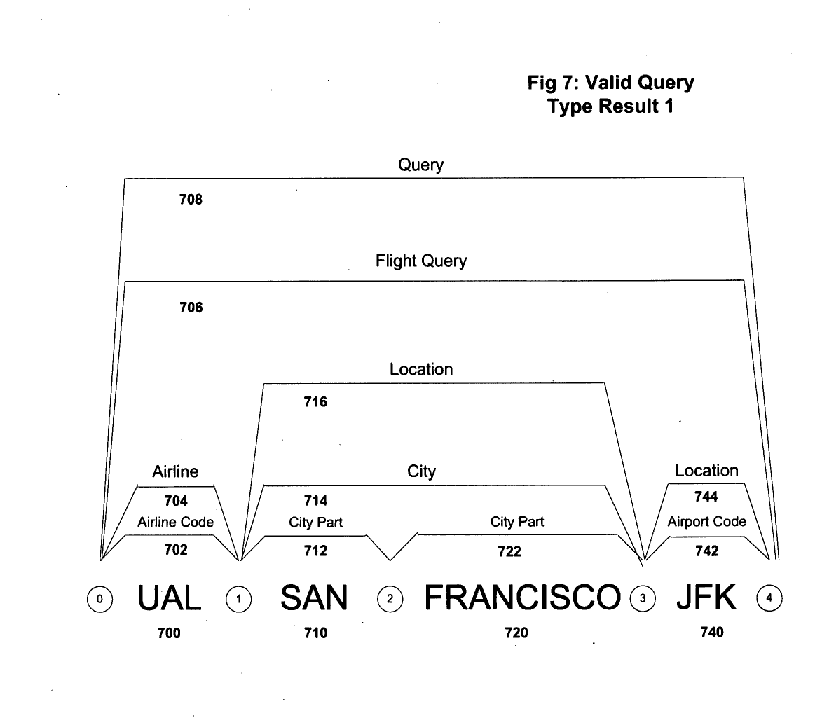

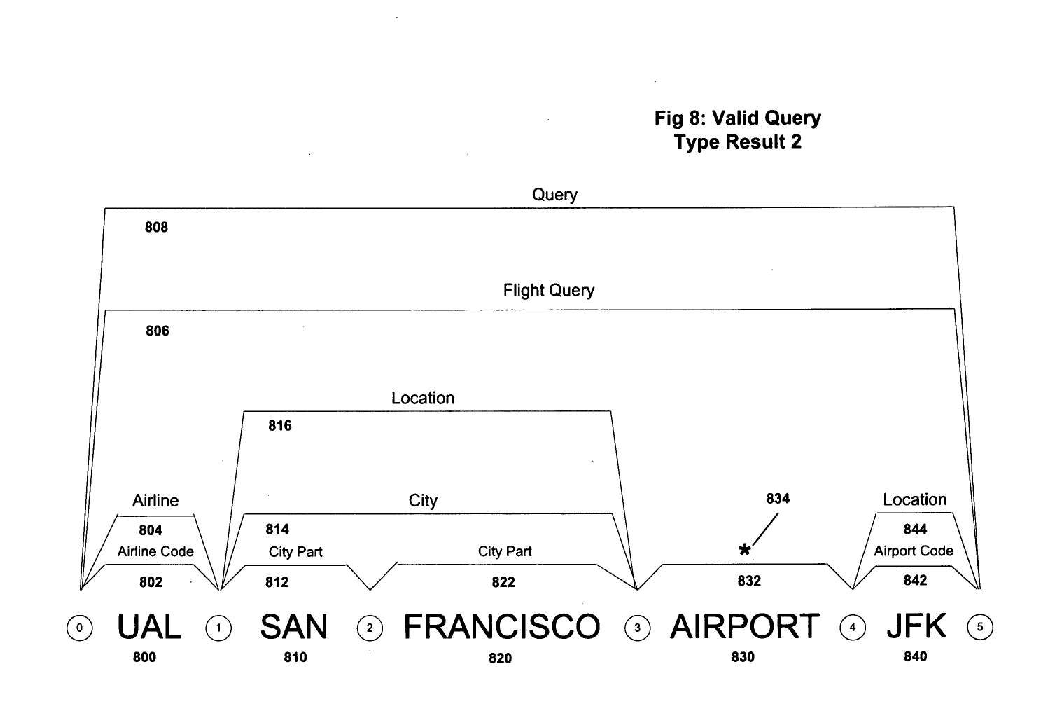

Referring now to FIGS. 7 and 8, examples of disambiguation are provided in which priority may be adjusted based on how well the interpretation fits the whole query entered. The drawings of FIGS. 7 and 8 illustrate valid query type results for two different search queries with similar meanings. In FIG. 7, a completed parse of a query string 708 written in the English Language is illustrated. Considering the illustration from a bottom up perspective, the query is typically tokenized and separated into 4 terminals: “UAL” 700, “SAN” 710, “FRANCISCO” 720 and “JFK” 740. Next, each terminal symbol may be identified by an associated phrase type such as “airline code” 702, a first “city part” 712, a second “city part” 722 and “airport code” 742, respectively. These identified phrase types may then be hierarchically translated upwards into their equivalent phrase type representations using the rules of the grammar. In this example, the phrase types are “Airline” 704, “City” 714 and “Location” 744. At the highest level, a semantic phrase type has been identified, namely “flight query” 706 that can be syntactically traced back to component terminals 700, 702, 704 and 706 of the query 708.

In FIG. 8, another example of a completed parse is illustrated involving a query 808 that is similar to the query 708 of FIG. 7. In this example, the query string 808 is tokenized into 5 separate terminal symbols: “UAL” 800, “SAN” 810, “FRANCISCO” 820, “AIRPORT” 830 and “JFK” 840. As in the example of FIG. 7, each terminal symbol 800, 810, 820, 830 and 840 is typically identified by a phrase type to which it belongs 802, 812, 822, 832 and 842. However, in the example of FIG. 8, the “AIRPORT” terminal symbol 830 is treated as a wildcard (as denoted by the *) 834. A wildcard 834 may be defined, for the purpose of this discussion, as a word that is not contained within the lexicon. In one example of how this system may be implemented, all rules of the grammar contain wildcards of length 0 or greater between any of the phrase types. Therefore, even though the terminal symbol “AIRPORT” 830 is not a recognized terminal symbol in the Lexicon, the parser is still able to determine that query string 808 represents a valid Flight Query 806.

In some embodiments of the invention, the processor also includes an adaptive probability engine to predict outcomes for a given set of test data and a set of required behavior. The probability engine maintains historical data including queries, predictions and actual outcomes. The probability engine adapts its predictive logic based on performance factors including information related to differences between predicted and observed outcomes. Adaptation may be implemented using methods and systems including Baysian and Neural networks.

In certain embodiments of the invention, the processor includes a terminal comparison component configured to adapt searches to overcome irregularities in queries such as at least some spelling mistakes. In at least some embodiments of the invention, the terminal comparison component includes a spell-checker, wherein spell-checkers are commonly known in the art. In one example, upon encountering the word “cofee,” the terminal comparison component may insert the missing “f” to provide a valid term that may be used in a search. In at least some embodiments, a context-sensitive spell-check component may correct spelling based on other information contained in a query. An example may be found in a flawed query such as “SAA SAN SJC,” wherein the flawed query is interpreted as a flight query for which no valid response is available. In the flawed query, the query may be interpreted as a request for South African Airlines (“SAA”) schedule of flights between San Diego (“SAN”) and San Jose (“SJC”) when no such schedule exists. However, the terminal comparison component may determine that “SAA” is spelled incorrectly because, for example, neither destination nor origination city is serviced by SAA and may deduce that the airline code “SWA” should be substituted since, in the example, a carrier designated SWA is found to provide a schedule between the SAN and SJC.

It will be appreciated that the terminal comparison component may base corrections on other factors including a number of changes required to provide a viable alternative for a flawed term. Further, in at least some embodiments, the terminal comparison component may use an iterative process of testing potential alternatives using the probability engine to predict likely combinations of corrections. Additionally, historical information related to misspellings may be used to select alternative terms. Thus, in some embodiments, a terminal comparison component may include a spell-checker and an associated spelling correction tool while, in other embodiments the terminal comparison component provides flexibility in lexicon lookup by, for example maintaining multiple entries for a term that include misspelled entries, acronyms and shortcuts. Similarly, other components may be used to associate audio clips with similarly sounding audio clips in a lexicon.

In at least some embodiments, repeated misspelling of one or more terms may be avoided by incorporating the one or more misspelled terms as aliases. The aliases may be adopted as system-wide aliases or may be associated with an individual, identifiable user. Prior histories may also be used to anticipate needs of an individual user, a category of user or as a presumption in conducting searches for all users. Prior history information may be used to preprocess information to be parsed by the processor. Preprocessing may accelerate searches by considering user habits over time. Thus, individual or categories of user preference may be used to predictively select search terms. Examples of user preference also include information service preferences, location-based preferences and preferences related to a current day, time-of-day and time-of-year.

Selection of terms may also be based on popularity of search types obtained by post-processing analysis of queries. Post-processing analysis may for example provide information to enable a rapid response to a query such as “94109,” if the results to “taxi 94109” is much more commonly sought than other potential queries associated with a five digit numerical code. Thus, based on prior usage of the system, given two results (A & B), the most likely result based on prior history will typically be presented first. In some embodiments, potential results are provided in menu form to permit better assessment of feedback or to display additional information.

Certain embodiments of the invention provide for adaptive implementations that prioritize results within an information service based on prior experience. Thus, for example, taxis may be considered to be more popular than tiger shops and taxi categories (such as Tiger Taxi Inc.) consequently receive higher priorities as a category than restaurant categories (such as The Stalking Tiger Restaurant) in response to a “tiger New York” entry. Analysis of prior queries and associated results may involve automated feedback systems, response systems for direct user feedback and human analysis. For example, a high frequency of query failures in a search domain may require adjustment of lexicon or grammar to better interpret received queries. Some embodiments provide components that enable the creation of general rules and help identify new words within lexicon and term types (non-terminals). For example, a basic grammar rule for an association between “location” and “city” may be improved to acknowledge that locations can include city, city state, zip code, area code, airport code information.

Although the present invention has been particularly described with reference to embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. It is intended that the appended claims include such changes and modifications. terminal symbols: “UAL” 800, “SAN” 810, “FRANCISCO” 820, “AIRPORT” 830 and “JFK” 840. As in the example of FIG. 7, each terminal symbol 800, 810, 820, 830 and 840 is typically identified by a phrase type to which it belongs 802, 812, 822, 832 and 842. However, in the example of FIG. 8, the “AIRPORT” terminal symbol 830 is treated as a wildcard (as denoted by the *) 834. A wildcard 834 may be defined, for the purpose of this discussion, as a word that is not contained within the lexicon. In one example of how this system may be implemented, all rules of the grammar contain wildcards of length 0 or greater between any of the phrase types. Therefore, even though the terminal symbol “AIRPORT” 830 is not a recognized terminal symbol in the Lexicon, the parser is still able to determine that query string 808 represents a valid Flight Query 806.

In some embodiments of the invention, the processor also includes an adaptive probability engine to predict outcomes for a given set of test data and a set of required behavior. The probability engine maintains historical data including queries, predictions and actual outcomes. The probability engine adapts its predictive logic based on performance factors including information related to differences between predicted and observed outcomes. Adaptation may be implemented using methods and systems including Baysian and Neural networks.

In certain embodiments of the invention, the processor includes a terminal comparison component configured to adapt searches to overcome irregularities in queries such as at least some spelling mistakes. In at least some embodiments of the invention, the terminal comparison component includes a spell-checker, wherein spell-checkers are commonly known in the art. In one example, upon encountering the word “cofee,” the terminal comparison component may insert the missing “f” to provide a valid term that may be used in a search. In at least some embodiments, a context-sensitive spell-check component may correct spelling based on other information contained in a query. An example may be found in a flawed query such as “SAA SAN SJC,” wherein the flawed query is interpreted as a flight query for which no valid response is available. In the flawed query, the query may be interpreted as a request for South African Airlines (“SAA”) schedule of flights between San Diego (“SAN”) and San Jose (“SJC”) when no such schedule exists. However, the terminal comparison component may determine that “SAA” is spelled incorrectly because, for example, neither destination nor origination city is serviced by SM and may deduce that the airline code “SWA” should be substituted since, in the example, a carrier designated SWA is found to provide a schedule between the SAN and SJC.

It will be appreciated that the terminal comparison component may base corrections on other factors including a number of changes required to provide a viable alternative for a flawed term. Further, in at least some embodiments, the terminal comparison component may use an iterative process of testing potential alternatives using the probability engine to predict likely combinations of corrections. Additionally, historical information related to misspellings may be used to select alternative terms. Thus, in some embodiments, a terminal comparison component may include a spell-checker and an associated spelling correction tool while, in other embodiments the terminal comparison component provides flexibility in lexicon lookup by, for example maintaining multiple entries for a term that include misspelled entries, acronyms and shortcuts. Similarly, other components may be used to associate audio clips with similarly sounding audio clips in a lexicon.

In at least some embodiments, repeated misspelling of one or more terms may be avoided by incorporating the one or more misspelled terms as aliases. The aliases may be adopted as system-wide aliases or may be associated with an individual, identifiable user. Prior histories may also be used to anticipate needs of an individual user, a category of user or as a presumption in conducting searches for all users. Prior history information may be used to preprocess information to be parsed by the processor. Preprocessing may accelerate searches by considering user habits over time. Thus, individual or categories of user preference may be used to predictively select search terms. Examples of user preference also include information service preferences, location-based preferences and preferences related to a current day, time-of-day and time-of-year.

Selection of terms may also be based on popularity of search types obtained by post-processing analysis of queries. Post-processing analysis may for example provide information to enable a rapid response to a query such as “94109,” if the results to “taxi 94109” is much more commonly sought than other potential queries associated with a five digit numerical code. Thus, based on prior usage of the system, given two results (A & B), the most likely result based on prior history will typically be presented first. In some embodiments, potential results are provided in menu form to permit better assessment of feedback or to display additional information.

Certain embodiments of the invention provide for adaptive implementations that prioritize results within an information service based on prior experience. Thus, for example, taxis may be considered to be more popular than tiger shops and taxi categories (such as Tiger Taxi Inc.) consequently receive higher priorities as a category than restaurant categories (such as The Stalking Tiger Restaurant) in response to a “tiger New York” entry. Analysis of prior queries and associated results may involve automated feedback systems, response systems for direct user feedback and human analysis. For example, a high frequency of query failures in a search domain may require adjustment of lexicon or grammar to better interpret received queries. Some embodiments provide components that enable the creation of general rules and help identify new words within lexicon and term types (non-terminals). For example, a basic grammar rule for an association between “location” and “city” may be improved to acknowledge that locations can include city, city state, zip code, area code, airport code information.

Although the present invention has been particularly described with reference to embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. It is intended that the appended claims include such changes and modifications.

What is claimed is:

1. A method for processing queries, comprising
parsing a query to obtain corresponding semantic interpretations;
obtaining search results based on the semantic interpretations; and
disambiguating the semantic interpretations and the search results to provide an optimal result.

2. The method of claim 1 wherein the step of parsing includes mapping known terminals of a search domain to corresponding phrase types.

3. The method of claim 1 wherein the step of parsing includes mapping a first set of phrase types to a second set of phrase types.

4. The method of claim 3 wherein mapping is based on an adaptive set of deterministic rules.

5. The method of claim 1 and further comprising
identifying one or more terminals in the query; and
assigning a probability to each of the one or more terminals.

6. The method of claim 1, and further comprising separating one or more terminals in the query to obtain a tokenized query.

7. The method of claim 6 and further comprising translating the one or more terminals using morphological analysis.

8. The method of claim 6 and further comprising assigning a probability to each of the one or more terminals in the tokenized query.

9. The method of claim 6 and further comprising storing one or more new terminals for processing future queries.

10. The method of claim 1, wherein disambiguating includes determining an optimum interpretation from the semantic interpretations.

11. The method of claim 10, wherein determining an optimum interpretation includes determining a most likely objective.

12. The method of claim 1, and further comprising the step of predicting the search results based on the query using an adaptive probability engine, wherein the probability engine maintains historical data including prior queries and corresponding predictions and results.

13. The method of claim 12, wherein the probability engine includes predictive logic that is adaptable in response to performance factors including information related to differences between predicted and observed results.

14. The method of claim 2 wherein the mapping includes updating a lexicon based on system usage, wherein the lexicon is for mapping the terminals to the phrase types.

15. The method of claim 3 wherein the mapping includes updating a grammar based on prior system usage, wherein the grammar maintains deterministic rules for mapping the first set of phrase types to the second set of phrase types.

16. The method of claim 15 wherein the mapping further includes updating the grammar based on user feedback.

17. A system for processing queries, comprising
a query parser for providing semantic interpretations of a query;
a service call manager for obtaining search results based on the semantic interpretations; and
a results analyzer for disambiguating the semantic interpretations and the search results to provide an optimal result.

18. The system of claim 17 wherein the parser includes a lexicon for mapping known terminals of a search domain to corresponding phrase types.

19. The system of claim 17 wherein the parser includes a grammar including deterministic rules for mapping a first set of phrase types to a second set of phrase types.

20. The system of claim 17 and further comprising a terminal comparison component for identifying terminals in the query.

21. The system of claim 20, wherein the terminal comparison component includes a spell checker.

22. The system of claim 21, wherein the spell checker is sensitive to context provided in the query.

23. The system of claim 21, wherein identification of the terminals includes identifying terminals based on misspellings in prior queries.

24. The system of claim 17 wherein the results analyzer provides an optimal result based on feedback from a user responsive to one or more ambiguous interpretations of the search results.
